(19) United States
(12) Patent Application Publication
(10) Pub. No.: US 2010/0229679 A1
(43) Pub. Date: Sep. 16, 2010

(54) Stepless positioning structure for telescopic tube

(76) Inventor: Chui-Teng LAI, Taichung (TW)

Correspondence Address: Dr. BANGER SHIA;Patent Office of Bang Shia, 102 Lindencrest Ct, Sugar Land, TX, 77479-5201, US

(21) Appl. No.: 12/404,314

(22) Filed: Mar. 15, 2009

(51) Int. Cl. F16H 35/08

(52) U.S. Cl. 74/829

(57) ABSTRACT

A stepless positioning structure for a telescopic tube includes a spindle, a spring, an elastic sleeve, a ball socket, and a plurality of balls. The elastic sleeve has a first central through hole, an inner end fixed to an inner end of an inner tube, and an outer end provided with an engaging section. The engaging section has a reduced portion at an outer end thereof. The ball socket is disposed in an outer tube, and has a second central through hole and a plurality of chambers formed on a side wall thereof. The chambers interconnect with the second central through hole of the ball socket. Either of upper and lower ends of each chamber is formed with a curve surface. The balls are accommodated in the chambers of the ball socket. The spindle is inserted through the spring, the first central through hole of the elastic sleeve, and the second central through hole of the ball socket. The spring holds against an inner end of the spindle and the elastic sleeve, respectively. An outer end of the spindle is secured to an outer end of the ball socket. The present invention achieves a stepless adjustment and provides a confinement function to the inner and outer tubes. This is convenient for operation.

### BACKGROUND OF THE INVENTION

1. Field of the Invention

The present invention relates to a positioning structure for telescopic inner and outer tubes.

2. Description of the Prior Art

There are many telescopic tube structures existing on the market, such as an umbrella rod, a tent rod, a fordable chair rod and the like. This telescopic tube structure is composed of an inner tube and an outer tube connected to each other. When in use, the inner tube is pulled out from the outer tube to lengthen the tube. When not in use, the inner tube is retracted into the outer tube to shorten the tube for storage and carriage. This telescopic tube structure is often used on a rod member for adjusting its length, such as a tent rod. With the telescopic tube structure, a tent is able to adjust its height and a mop handle may be adjusted for a different user.

The aforesaid telescopic tube structure needs to secure the inner and outer tubes for maintaining the pulled length. A conventional positioning structure comprises fixing holes and fixing protuberances to engage with each other. This positioning structure has the following shortcomings:
1. The fixing holes are formed on the outer tube, which influences the strength of the outer tube.
2. It is necessary to provide more fixing holes for providing more different lengths of the telescopic tube. The more the fixing holes are, the weaker the outer tube is. The adjustment is subjected to the number of the fixing holes, and it is unable to provide a stepless adjustment.
3. It is required to press the fixing protuberances into the outer tube for retracting or extending the tube. Sometimes the operation is strenuous.

Thus it can be seen, the conventional positioning structure for a telescopic tube is not convenient in use and doesn't provide a stepless adjustment. Accordingly, the inventor of the present invention has devoted himself based on his many years of practical experiences to the development of a positioning structure for a telescopic tube.

### SUMMARY OF THE INVENTION

The objective of the present invention is to provide a stepless positioning structure for a telescopic tube, which is convenient to position the telescopic tube and provides a stepless adjustment.

According to the present invention, there is provided a stepless positioning structure for a telescopic tube, comprising a spindle, a spring, an elastic sleeve, a ball socket, and a plurality of balls; the elastic sleeve having a first central through hole, an inner end fixed to an inner end of an inner tube, and an outer end provided with an engaging section, the engaging section having a reduced portion at an outer end thereof; the ball socket being disposed in an outer tube, the ball socket having a second central through hole and a plurality of chambers formed on a side wall thereof, the chambers interconnecting with the second central through hole of the ball socket, either of upper and lower ends of each chamber being formed with a curve surface; the balls being accommodated in the chambers of the ball socket; the spindle being inserted through the spring, the first central through hole of the elastic sleeve, and the second central through hole of the ball socket, the spring holding against an inner end of the spindle and the elastic sleeve respectively, an outer end of the spindle being secured to an outer end of the ball socket.

Preferably, the balls are in a drum shape.

Preferably, the ball socket is composed of an upper cover and a lower cover, the upper cover being provided with a number of engaging hooks and the lower cover being formed with a number of engaging notches to engage with the engaging hooks.

Preferably, the upper cover and the lower cover are formed with recesses facing each other to form the chambers, at least one of the recesses having a bottom formed with the curve surface.

Preferably, either of the upper cover and the lower cover is formed with recesses to form the chambers, the recesses each having a bottom formed with the curve surface.

Preferably, the outer end of the spindle is formed with an engaging groove, the spindle being inserted through the upper cover of the ball socket, an engaging ring being provided to engage with the engaging groove.

Preferably, the engaging section has a straight portion at an inner end thereof.

The balls of the present invention are driven by the engaging section of the elastic sleeve to extend out the chambers or retract into the chambers. When the balls extend out the chambers to hold against the inner wall of the outer tube, the inner and outer tubes will be positioned by the balls. This provides a confinement function. When the balls retract into the chambers, the inner and outer tubes will be adjustable as desired. This structure provides a stable engagement, achieves a stepless adjustment, and is convenient for operation.

In addition, one end of each chamber is formed with the curve surface corresponding in shape to the balls. When the balls are not held by the engaging section of the elastic sleeve, the balls are in a free status. The curve surface makes the balls retract into the chamber so the friction between the balls and the inner wall of the outer tube is obviated, preventing the balls from being jammed.

Furthermore, the balls are shaped like a drum, increasing contact area between the balls and the outer sleeve so as to increase friction and enhance locking force.

### BRIEF DESCRIPTION OF THE DRAWINGS

FIG. 1 is an exploded view according to a first preferred embodiment of the present invention;

FIG. 2 is a cross-sectional view according to the first preferred embodiment of the present invention;

FIG. 3 is a perspective view according to the first preferred embodiment of the present invention before pressing a spring;

FIG. 4 is a perspective view according to the first preferred embodiment of the present invention after pressing the spring;

FIG. 5 is a cross-sectional view showing the first preferred embodiment of the present invention mounted in inner and outer tubes in a locked status before pressing the spring;

FIG. 6 is a cross-sectional view showing the first preferred embodiment of the present invention mounted in the inner and outer tubes in an adjustable status after pressing the spring; and

FIG. 7 is a cross-sectional view according to a second preferred embodiment of the present invention

### DETAILED DESCRIPTION OF THE PREFERRED EMBODIMENT

Embodiments of the present invention will now be described, by way of example only, with reference to the accompanying drawings.

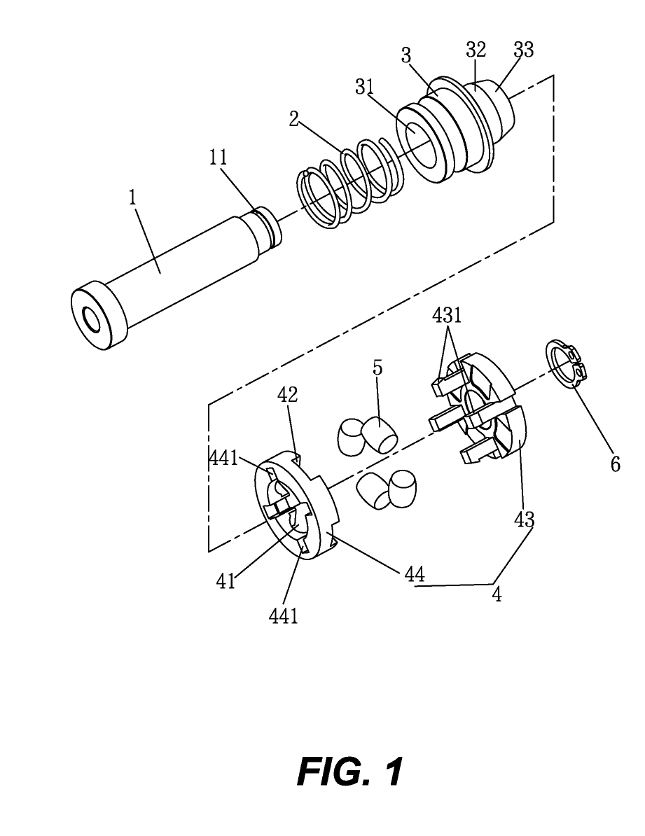

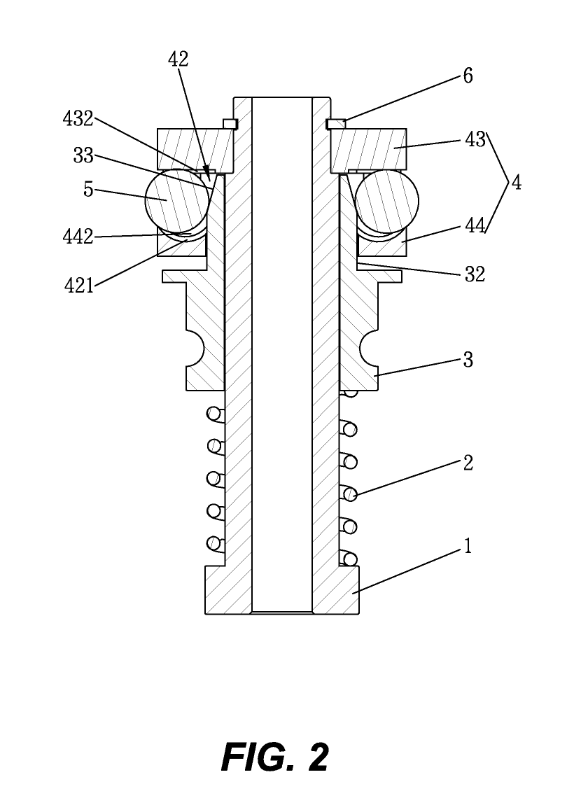

As shown in FIGS. 1 and 2, a stepless positioning structure for a telescopic tube according to a first embodiment of the present invention comprises a spindle 1, a spring 2, an elastic sleeve 3, a ball socket 4, and a plurality of balls 5.

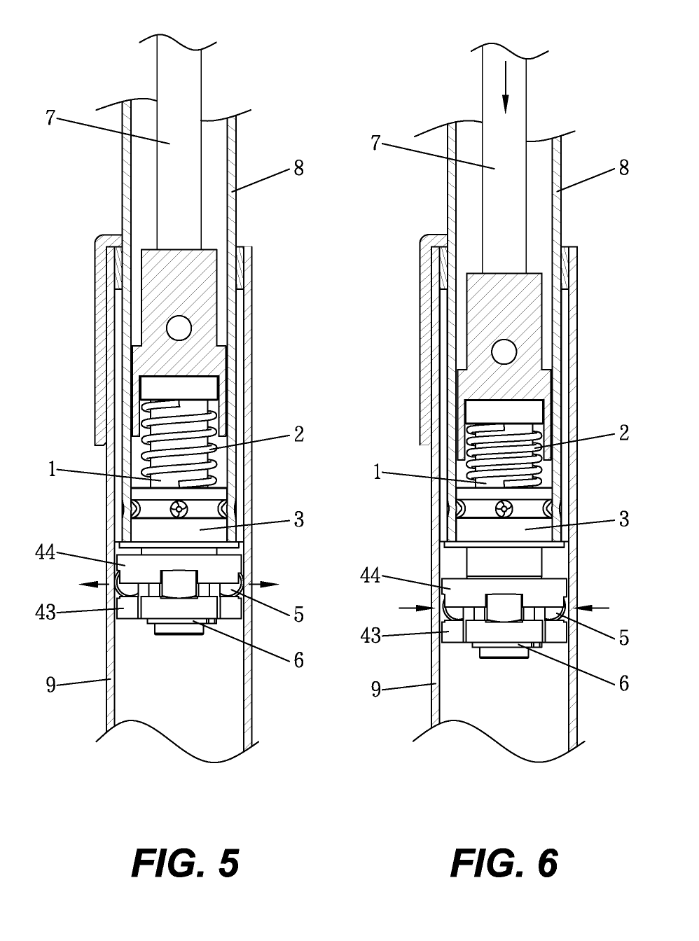

The elastic sleeve 3 has a first central through hole 31, an inner end fixed to an inner end of an inner tube 8 (referring to FIGS. 5 and 6), and an outer end provided with an engaging section. The engaging section has a straight portion 32 at an inner end and a reduced portion 33 at an outer end thereof.

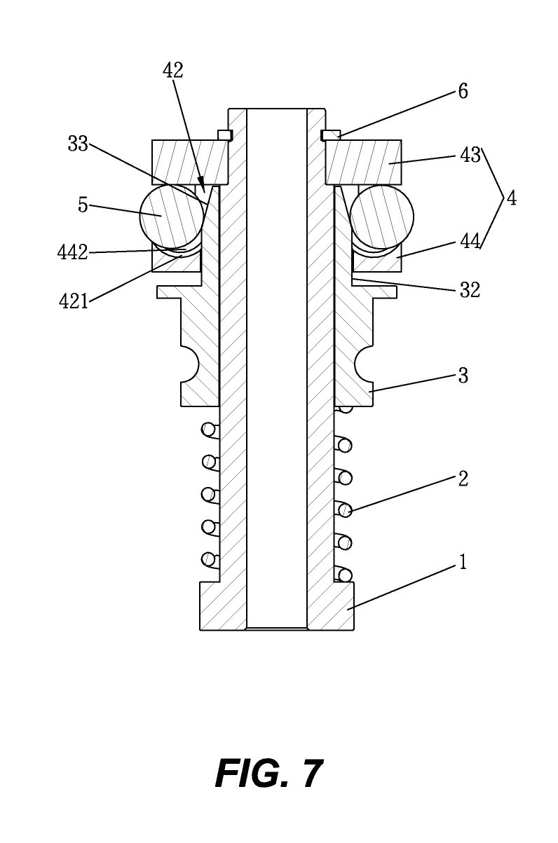

The ball socket 4 is disposed in an outer tube 9, referring to FIGS. 5 and 6. The ball socket 4 has a second central through hole 41 and a plurality of chambers 42 formed on a side wall thereof. The chambers 42 interconnect with the second central through hole 41. Either of upper and lower ends of each chamber 42 is formed with a curve surface 421. In this embodiment, the ball socket 4 is composed of an upper cover 43 and a lower cover 44. The upper cover 43 is provided with a number of engaging hooks 431 and the lower cover 44 is formed with a number of engaging notches 441 to engage with the engaging hooks 431 so the upper cover 43 and the lower cover 44 are connected together. The upper cover 43 and the lower cover 44 are formed with recesses 432 and 442 facing each other to form the chambers 42, as shown in FIG. 2. Alternatively, either of the upper and lower covers 43 and 44 is formed with the recesses 442, as shown in FIG. 7. One of the recesses 432 and 442 has a bottom formed with the curve surface 421. As shown in FIGS. 2 and 7, the curve surface 421 is formed on the bottom of the recess 442 of the lower cover 44.

The balls 5 are accommodated in the chambers 42 of the ball socket 4 for increasing contact area and friction to enhance locking force. The balls 5 may be in a drum shape.

The spindle 1 is inserted through the spring 2, the first central through hole 31 of the elastic sleeve 3, and the second central through hole 41 of the ball socket 4. The spring 2 holds against the inner end of the spindle 1 and the elastic sleeve 3, respectively. The outer end of the spindle 1 is secured to the outer end of the ball socket 4. In this embodiment, the outer end of the spindle 1 is formed with an engaging groove 11. When the spindle 1 is inserted through the upper cover 43 of the ball socket 4, an engaging ring 7 is provided to engage with the engaging groove 11 so as to secure the spindle 1 at the outer end of the upper cover 43 of the ball socket 4.

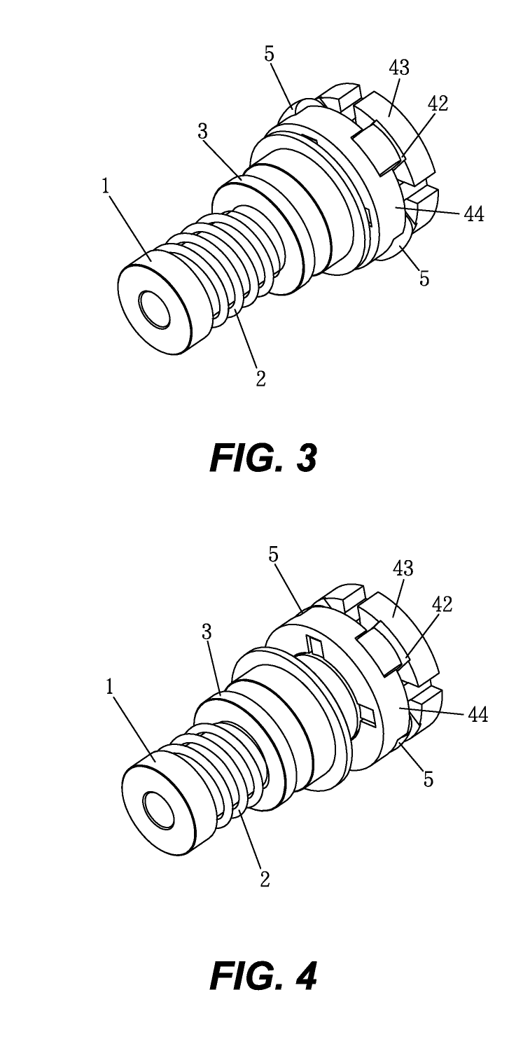

When the present invention is in use, the inner end of the elastic sleeve 3 is secured to the end of the inner tube 8, and then the inner tube 8 and the positioning structure are inserted into the outer tube 9, as shown in FIGS. 5 and 6. As shown in FIGS. 3 and 5, when the spring 2 is not pressed, the spindle 1 urged by the spring 2 will move toward one side of the inner tube 8 for pulling the ball socket 4 to lean on the elastic sleeve 3. The engaging section at the outer end of the elastic sleeve 3 extends into the second central through hole 41 of the ball socket 4 so that the top of the reduced portion 33 or the straight portion 32 faces the balls 5. The balls 5 are pushed by the engaging section to move outward and each ball 5 has a portion exposed outside the chamber 42 to hold against the inner wall of the outer tube 9 such that the inner and outer tubes 8 and 9 are positioned in place, achieving a confinement function. The straight portion 32 is able to lock the balls 5 steady.

As shown in FIGS. 4 and 6, when the spindle 1 is pressed from the inner tube 8 or the spindle 1 is pulled from the outer tube 9 (in this embodiment a push rod 7 connected to the spindle 1 is provided in the inner sleeve 8), the spring 2 will be compressed and the spindle 1 will drive the ball socket 4 to move toward one side of the outer tube 9 such that the ball socket 4 disengages from the elastic sleeve 3. The straight portion 32 of the engaging section at the outer end of the elastic sleeve 3 disengages from the balls 5. The straight portion 32 or the reduced portion 33 doesn't hold against the balls 5 so the inner tube 8 is adjustable as desired. The curve surface 421 helps the balls 5 retract into the chambers 42 automatically to obviate frication between the balls 5 and the inner wall of the outer tube 9, preventing the balls from being jammed.

When the inner and outer tubes 8 and 9 are expanded or retracted to a desired position, the push rod 7 is loosened to release the spindle 1, the balls 5 hold against the inner wall of the outer tube 9 to position the inner and outer tubes in place.

Except the push rod 7, the inner and outer tubes may be provided with a wire rope or a pull rope to control the movement of the spindle 1, providing a far end control positioning function.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A stepless positioning structure for a telescopic tube, comprising a spindle, a spring, an elastic sleeve, a ball socket, and a plurality of balls; the elastic sleeve having a first central through hole, an inner end fixed to an inner end of an inner tube, and an outer end provided with an engaging section, the engaging section having a reduced portion at an outer end thereof; the ball socket being disposed in an outer tube, the ball socket having a second central through hole and a plurality of chambers formed on a side wall thereof, the chambers interconnecting with the second central through hole of the ball socket, either of upper and lower ends of each chamber being formed with a curve surface; the balls being accommodated in the chambers of the ball socket; the spindle being inserted through the spring, the first central through hole of the elastic sleeve, and the second central through hole of the ball socket, the spring holding against an inner end of the spindle and the elastic sleeve respectively, an outer end of the spindle being secured to an outer end of the ball socket.

2. The stepless positioning structure for a telescopic tube as claimed in claim 1, wherein the balls are in a drum shape.

3. The stepless positioning structure for a telescopic tube as claimed in claim 1, wherein the ball socket is composed of an upper cover and a lower cover, the upper cover being provided with a number of engaging hooks and the lower cover being formed with a number of engaging notches to engage with the engaging hooks.

4. The stepless positioning structure for a telescopic tube as claimed in claim 2, wherein the ball socket is composed of an upper cover and a lower cover, the upper cover being provided with a number of engaging hooks and the lower cover being formed with a number of engaging notches to engage with the engaging hooks.

5. The stepless positioning structure for a telescopic tube as claimed in claim 4, wherein the upper cover and the lower cover are formed with recesses facing each other to form the chambers, at least one of the recesses having a bottom formed with the curve surface.

6. The stepless positioning structure for a telescopic tube as claimed in claim 4, wherein either of the upper cover and the lower cover is formed with recesses to form the chambers, the recesses each having a bottom formed with the curve surface.

7. The stepless positioning structure for a telescopic tube as claimed in claim 1, wherein the outer end of the spindle is formed with an engaging groove, the spindle being inserted through the upper cover of the ball socket, an engaging ring being provided to engage with the engaging groove.

8. The stepless positioning structure for a telescopic tube as claimed in claim 2, wherein the outer end of the spindle is formed with an engaging groove, the spindle being inserted through the upper cover of the ball socket, an engaging ring being provided to engage with the engaging groove.

9. The stepless positioning structure for a telescopic tube as claimed in claim 1, wherein the engaging section has a straight portion at an inner end thereof.

10. The stepless positioning structure for a telescopic tube as claimed in claim 2, wherein the engaging section has a straight portion at an inner end thereof.
